(19) United States
(12) Patent Application Publication
(10) Pub. No.: US 2026/0208333 A1
(43) Pub. Date: Jul. 23, 2026

(54) TORQUE DRIVER

(71) Applicant: AOB Products Company, Columbia, MO (US)

(72) Inventors: Paul Coryell, Columbia, MO (US); Kolten Kelsey, Columbia, MO (US); Michael Cottrell, Ashland, MO (US); Michael Lindsay, Columbia, MO (US); Daniel Jennings, Columbia, MO (US); James Tayon, Moberly, MO (US); Jarrod Grove, Columbia, MO (US); Jared Hunter, Columbia, MO (US)

(73) Assignee: AOB Products Company, Columbia, MO (US)

(21) Appl. No.: 19/450,655

(22) Filed: Jan. 15, 2026

Related U.S. Application Data
(60) Provisional application No. 63/746,748, filed on Jan. 17, 2025.

(51) Int. Cl. B25B 23/147; B25F 5/00; B25F 5/02

(52) U.S. Cl. CPC B25B 23/147; B25F 5/02; B25F 5/001

(57) ABSTRACT

A torque driver for rotating a component and associated components and methods. The torque driver includes a housing, a motor having an output shaft, a component receiver for receiving the component, and a torque sensor assembly connected to the housing. The motor is connected to the torque sensor assembly. The output shaft is operably connected to the component receiver to rotate the component receiver. The torque driver includes a controller for operating the motor based on a torque measurement from the torque sensor assembly.

### CROSS-REFERENCE TO RELATED APPLICATION

The present application claims priority to U.S. Provisional Patent Application No. 63/746,748, filed Jan. 17, 2025, the entirety of which is hereby incorporated by reference.

### FIELD

The present disclosure relates to power tools for fastening applications, and more particularly to a power torque driver with torque sensing.

### BACKGROUND

Power tools for fastening applications provide users with the ability to efficiently install and remove various types of fasteners (e.g., screws, bolts).

### SUMMARY

In one aspect, a torque driver for rotating a component comprises a housing, a component receiver configured to receive the component, and a torque sensor assembly connected to the housing. The torque driver further comprises a motor connected to the torque sensor assembly. The motor has an output shaft operably connected to the component receiver to rotate the component receiver. The torque driver also comprises a controller configured to operate the motor based on a torque measurement from the torque sensor assembly.

In another aspect, a torque driver comprises a housing, a component receiver configured to receive the component, and a motor having an output shaft operably connected to the component receiver to rotate the component receiver. The torque driver further comprises a torque sensor assembly configured to measure a torque being applied to the component by the torque driver. The torque driver also comprises a user interface configured to permit a user to input a torque threshold, the user interface including a torque control actuator. The torque driver additionally comprises a controller configured to operate in a first mode in which the controller operates the motor based on the torque threshold and a second mode in which the controller operates the motor independent of the torque threshold. The controller is configured to switch between the first and second modes in response to actuation of the torque control actuator.

Other objects and features of the present disclosure will be in part apparent and in part pointed out hereinafter.

### BRIEF DESCRIPTION OF DRAWINGS

FIG. 1 is a rear perspective of a torque driver according to an embodiment of the present disclosure;

FIG. 2 is a front perspective of the torque driver;

FIG. 3 is an elevation view of the torque driver;

FIG. 4 is a front view of the torque driver;

FIG. 5 is a rear view of the torque driver;

FIG. 6 is an elevation view of the torque driver with a portion of a housing of the torque driver removed to show interior details;

FIG. 7 is a partially exploded view of the torque driver;

FIG. 8 is a perspective of a torque sensor assembly of the torque driver;

FIG. 9 is a schematic diagram of a control system of the torque driver;

FIG. 10 is a perspective view of a clutch assembly according to another embodiment of the present disclosure; and

FIG. 11 is a schematic diagram of the torque driver of FIG. 10.

Corresponding reference characters indicate corresponding parts throughout the drawings.

### DETAILED DESCRIPTION

The present disclosure relates to torque drivers for fastening applications (e.g., a power or electric drill, power or electric screwdriver, cordless drill or screwdriver, and/or impact driver, broadly “the driver”). The torque driver enables a user to select a torque threshold up to which the torque driver will drive a component. Specifically, the torque driver provides powered (e.g., electrically powered) means of tightening components accurately to a known or desired torque threshold by reducing (e.g., terminating or uncoupling) power delivery to the motor based on torque measurements from a torque sensor assembly.

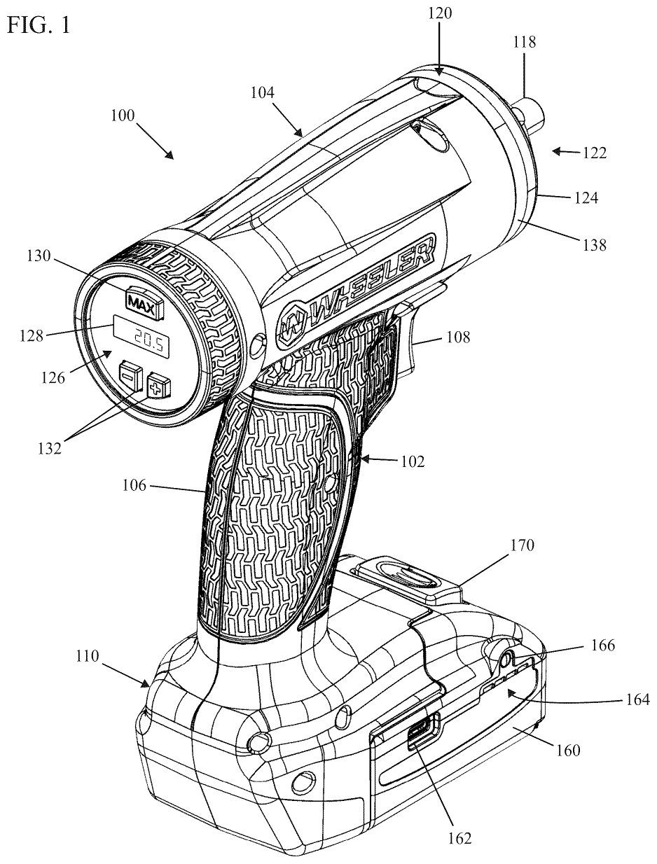

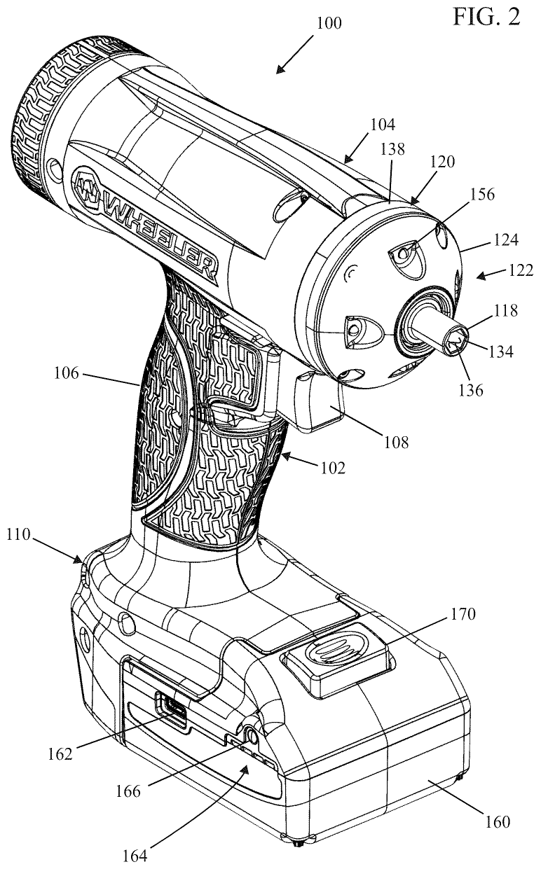

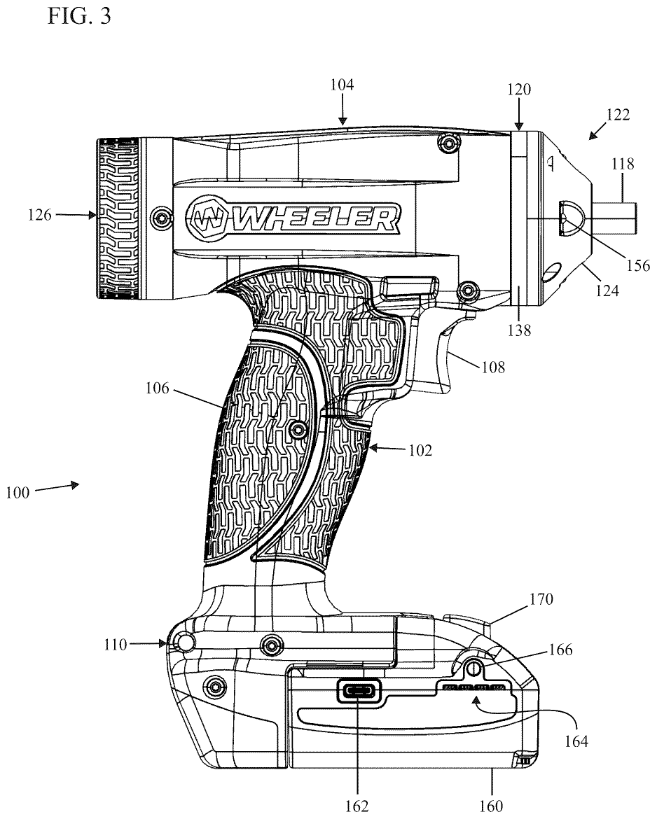

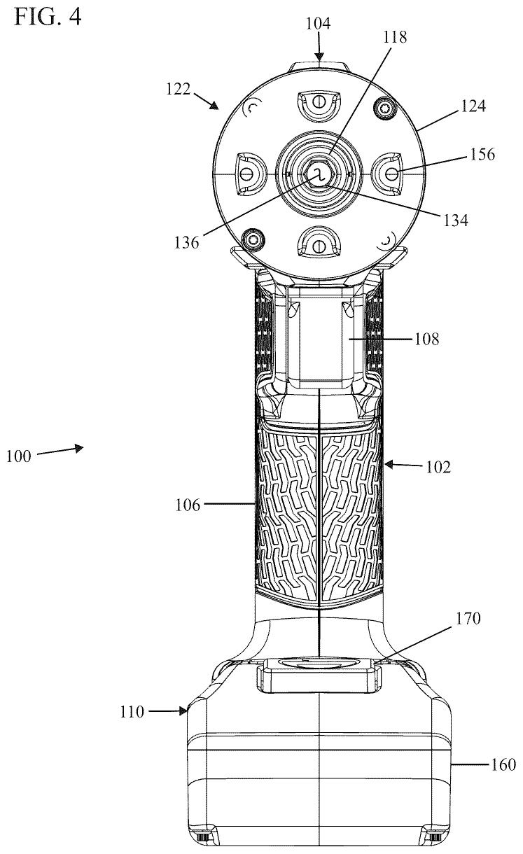

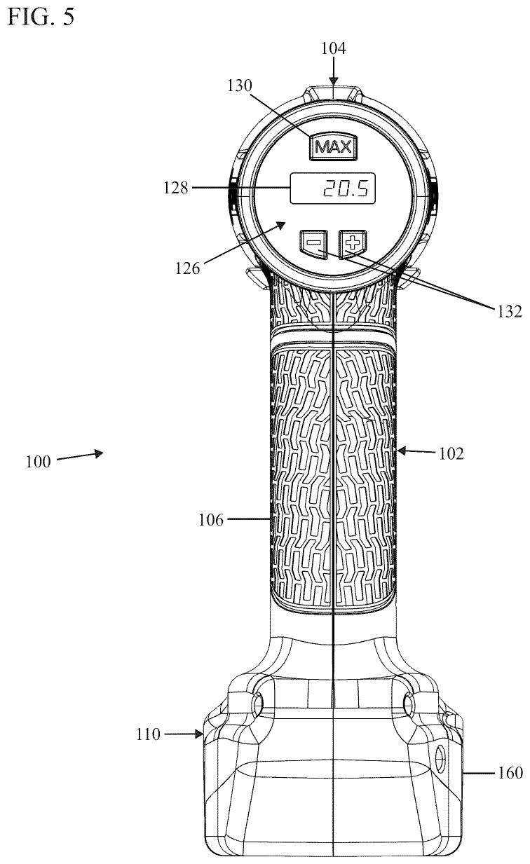

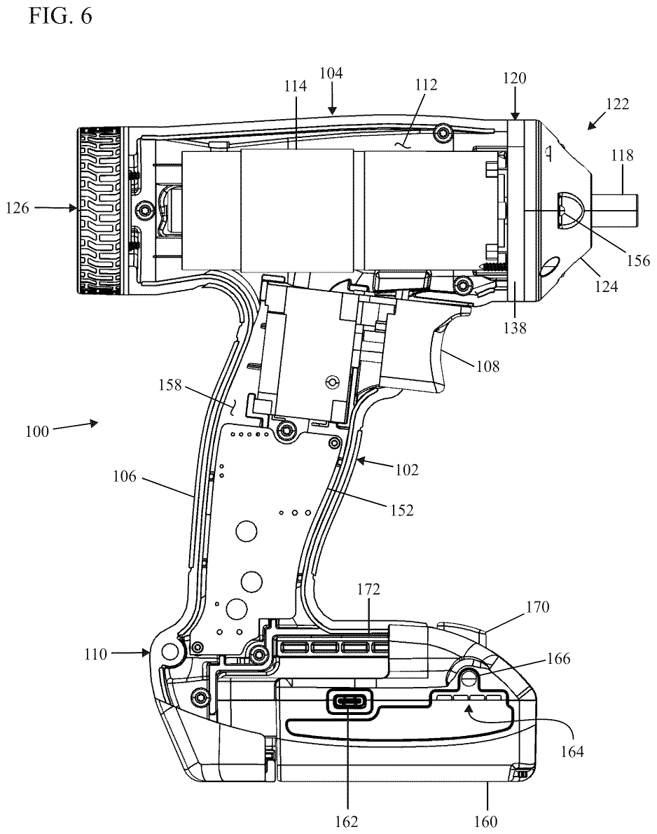

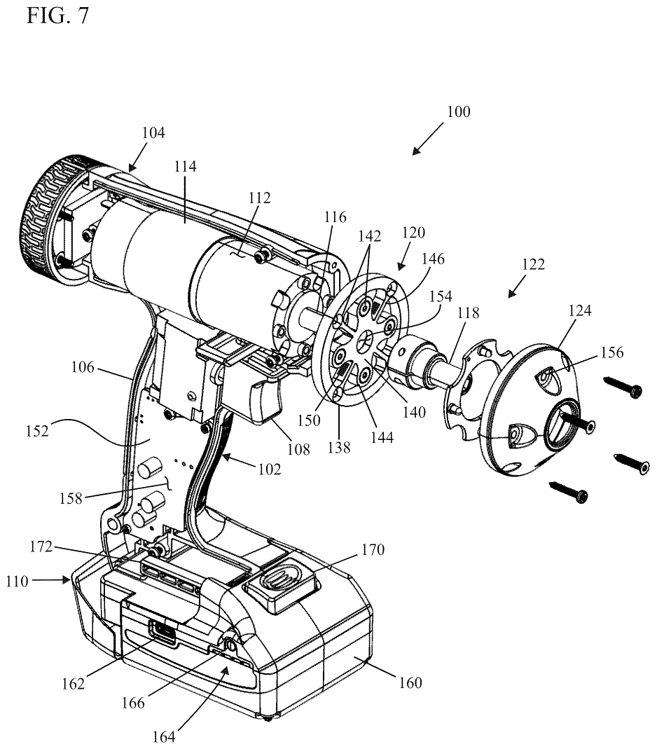

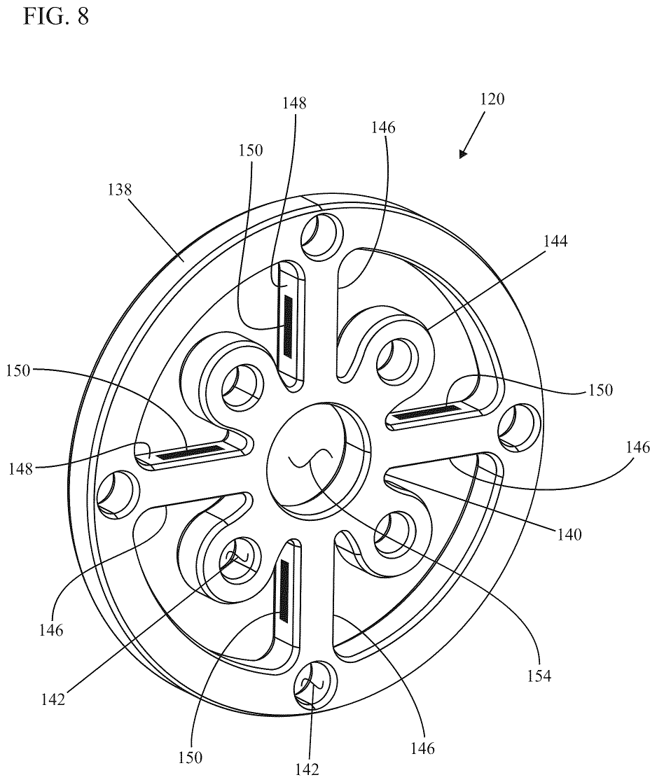

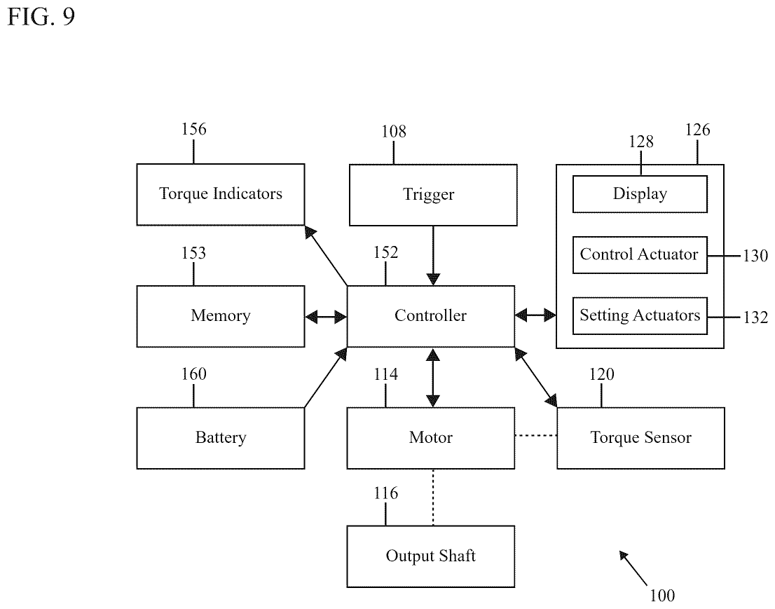

Referring to FIGS. 1-9, one embodiment of the torque driver according to the present disclosure is generally indicated at reference number 100. The driver 100 includes a driver housing 102 having a pistol-grip configuration for providing handling to users. The driver comprises a head 104, a handle 106 including a variable-position trigger 108 (broadly, actuator), and a base 110. The head 104 is connected to the handle 106 at an upper end thereof, and the base 110 is connected to the handle 106 at a lower end thereof. The head 104 has a substantially cylindrical shape that extends forward (distally, away from a user during use) and rearward (proximally, toward a user during use) from the handle 106. The head 104 defines an interior head space 112 for holding mechanical and electronic components therein while providing structural support and protection. The head 104 includes drive components of the driver 100 (e.g., the motor 114, output shaft 116, component receiver 118) as well as at least one sensor (e.g., the torque sensor assembly 120) and terminates at a front end with an output shaft assembly 122. In the illustrated embodiment, the output shaft assembly 122 includes a cap 124 and a single-size hexagonal bit receiver as the component receiver 118. The component receiver 118 is operatively coupled to the output shaft 116. Other shaft assemblies (e.g., a chuck for releasably retaining bits of differing sizes) can be used without departing from the scope of the present disclosure. In addition, other housing configurations can be used without departing from the scope of the present disclosure.

The driver 100 includes a user interface 126 for monitoring and controlling driver functions. The user interface 126 is supported by the driver housing 102. In the illustrated embodiment, the user interface 126 is mounted on the head 104. The user interface 126 is positioned at the proximal end of the head 104. The user interface 126 includes a display 128 (e.g., a screen), one or more torque control actuators 130, and one or more torque setting actuators 132 for providing user monitoring and control of driver functions. In the illustrated embodiment, the actuators 130, 132 comprise buttons, although other types of actuators can be used without departing from the scope of the present disclosure.

The display 128 visually presents information to the user or operator. Such information can include a user-selected torque threshold (e.g., 1 lbf-ft, 10 lbf-ft, 50 lbf-ft, etc.), an applied torque (e.g., a measured torque acquired by the torque sensor assembly 120 during operation), and various operational modes or states of the driver (e.g., on, off, torque-limiting, non-torque-limiting, overheat, low battery, charging, etc.). The display 128 provides visibility of numerical torque values, which can be expressed in units such as pound-feet (lbf-ft) or Newton-meters (Nm). The driver 100 can be configured to permit user selection of torque units depending on user preference or application requirements. In general, the user interface 126 is configured to show the torque threshold (selected by the user) and is additionally configured to show the applied torque (measured by the torque sensor assembly 120). The user interface 126 can show the torque threshold and the applied torque simultaneously or one at a time.

The torque setting actuators 132 enable the user to control or set the torque threshold. In the illustrated embodiment, the torque setting actuators 132 are labeled with “+” (plus) and “−” (minus) indicia to facilitate ease of understanding with respect to their function. When viewed from the position of a user holding the driver 100, the leftmost torque setting actuator 132 (e.g., “−”) decreases torque, while the rightmost torque setting actuator (e.g., “+”) increases torque. Torque adjustments via the torque setting actuators 132 may occur in single unit increments for enabling precise torque adjustments (e.g., ±1 ft-lb, ±1 N-M). Torque adjustments may also be performed in larger increments (e.g., ±5 ft-lb, ±10 ft-lb, ±5 N-M, ±10 N-M) or smaller increments (e.g., ±0.1 ft-lb, ±0.01 ft-lb, ±0.1 N-M, ±0.01 N-M). In one embodiment, a single press (e.g., press and release in less than a second) changes the setting of the torque threshold by a single unit increment and a sustained press and hold (e.g., press and not release) changes the setting of the torque threshold by a larger increment.

The torque control actuator 130 is a torque mode input for enabling the user to rapidly toggle between control modes of the controller 152. The driver 100 is operatable in different modes, such as one mode with torque control and another mode without torque control. The controller 152 is configured to operate in a first mode in which the controller 152 operates the motor 114 based on the torque threshold (a torque-controlled mode) and a second mode in which the controller 152 operates the motor 114 independent of the torque threshold (a non-torque controlled mode). The controller 152 is configured to switch between the first and second modes in response to actuation of the torque control actuator 130. In the non torque controlled mode, the motor 114 (broadly, the driver 100) is operated independent of any torque threshold. In other words, the amount of applied torque by the motor 114 is not controlled and the motor applies as much torque as possible to the component being rotated. In the torque controlled mode, the motor 114 (broadly, the driver 100) is operated based on the torque threshold. The motor 114 stops operating (e.g., stops rotating and applying torque) to the component being rotated when the applied torque meets or exceeds the torque threshold set by the operator. The non torque-controlled mode is functionally identical to removing consideration (by the controller 152) of the torque threshold and permitting unrestricted power delivery to the motor 114 (i.e., maximum power). The torque control actuator 130 provides operational flexibility with respect to whether the value of applied torque is important for the specific application. For example, a user may enter the non-torque controlled mode when removing components already installed, as the applied torque value is generally not of importance during component removal. Conversely, the user may enter the torque-controlled mode when driving a component of a workpiece which is sensitive to over tightening, and thus requires limiting the applied torque.

The user interface 126 may accommodate various input modalities. In alternative embodiments, the user interface 126 may be implemented as a digital system, such as through a touchscreen interface which serves dual functions as both the display 128 and the input mechanism for user selection (the torque control actuator 130 and the torque setting actuators 132). For example, the touchscreen can present virtual buttons, sliders, or numerical input fields that users can manipulate to adjust torque settings (e.g., the torque threshold). Other types of analog adjusters or selectors may be incorporated, such as dials for incrementally increasing or decreasing the desired torque threshold. Other configurations of the user interface can be used without departing from the scope of the present disclosure.

The head 104 houses the electric motor 114 which extends longitudinally along the interior 112. The motor 114 can be a DC motor configured to convert electrical energy from the battery 160 into mechanical rotational energy for driving a component. The output shaft 116 extends to the distal end of the head 104 and delivers the motor's 114 power to the component receiver 118 operatively coupled thereto (operatively coupled to the output shaft of the motor). In the illustrated embodiment, the output shaft 116 is directly connected to the component receiver 118. The component receiver 118 (broadly, component driver) includes a component sleeve or shaft 134 defining a component receival space 136. Thus, the component receiver 118 can accommodate various types of bits to provide versatility. In the illustrated embodiment, the component receival space 136 has a hexagonal cross-section for receiving a bit (e.g., screwdriver bit). Other configurations of the component receiver can be used without departing from the scope of the present disclosure.

The head 104 includes the torque sensor assembly 120 for precise measurement and control of motor 114 output. The torque sensor assembly 120 is incorporated at the head 104 to measure the torque output for providing feedback to the controller 152 for operations thereof. The torque sensor assembly 120 is configured to sense torque at the motor 114 rather than at the output shaft 116 to provide direct measurement of the motor's torque output before loss may be incurred through contact with other components. The motor 114 is mounted directly to the torque sensor assembly 120, with the torque sensor assembly 120 itself being mounted to and supported by the head 104. The motor 114 is supported in the interior 112 of the housing 102 in a way that permits the motor to rotate relative to the housing. The rotation of the motor 114 relative to the housing 102 is due to the torque being applied by the motor and the resistance of the component being rotated. In one embodiment, the motor 114 may rotate less than 10-degrees about the axis of rotation of the motor due to the applied torque.

Desirably, the motor 114 is supported solely by the torque sensor assembly 120. The motor 114 is freely suspended within the housing 102 through its connection to the torque sensor assembly 120. In the illustrated embodiment, the torque sensor assembly 120 has an outermost radius substantially equal to that of the housing 102 at the head 104, and is sandwiched against the housing by the output shaft assembly 122. In alternative embodiments, the torque sensor assembly 120 may be enclosed by the housing 102 at the head 104. The torque sensor assembly 120 detects deformation and converts it into electrical signals (broadly, torque data) that correspond to the applied torque (i.e., the real-time torque output of the driver 100). The sensor 120 thus provides applied torque data to the controller 152 for enabling precise control of motor 114 output to achieve the desired torque output (e.g., the threshold torque as defined by the user via their selection of the torque threshold and/or through selective depression of the variable-position trigger 108).

The torque sensor assembly 120 includes dual connectors for interfacing with both the housing 102 and motor 114. The torque sensor assembly 120 includes a housing connector 138 for connecting to the housing 102 at the head 104 and a motor connector 140 for connecting to the motor 114. The housing connector 138 has an annular shape and defines fastener openings 142 equally distributed about its circumference. The radial spacing of the fastener openings 142 promotes balanced load distribution and secure attachment to the head 104. The motor connector 140 is nested radially inward with respect to the housing connector 138. The motor connector 140 is configured to fixedly attach the torque sensor assembly 120 to the motor 114. The motor connector 140 includes connector arms 144 which extend radially outward (e.g., away from rotational axis of motor output shaft), with each arm defining a fastener opening for securing the motor 114 to the motor connector. The arrangement of the housing connector 138 and the motor connector 140 positions the motor 114 concentrically within the head 104, isolating the motor from contact with the housing 102. Desirably, the motor connector 140 is the only point of fixed connection for the motor 114. In other embodiments, the motor can be otherwise supported, but such supports do not inhibit the motor from rotating relative to the housing.

The housing and motor connectors 138, 140 are moveable (e.g., rotatable) relative to one another. In particular, the motor connector 140 is rotatable about the axis of rotation (of the motor output shaft) relative to the housing connector. The torque sensor assembly 120 includes links 146 (e.g., at least one link) for enabling torque measurement through mechanical deformation. The housing connector 138 and the motor connector 140 are coupled via links 146 which span the radial gap therebetween. The links extend radially outward away from the axis of rotation of the motor output shaft. The links 146 are configured to deform (e.g., flex, bend) when torque is applied between the motor 114 and the housing 102 (e.g., when the motor operates). The motor 114 and the motor connector 140 rotate relative to the housing 102 and the housing connector 138 in response to the applied torque to deform the links 146. The links 146 include side surfaces 148 for providing a surface on which to mount torque sensing electronics. The links 146 can comprise ribs, walls, struts, or beams. The links can be made of metal or any other suitable material and are relatively thin in order to deform due to the applied torque. The torque sensor assembly 120 includes at least one sensor 150 (e.g., torque sensor). The sensors 150 sense or determine torque data. In the illustrated embodiment, the torque sensor assembly 120 includes four sensors 150. Each sensor 150 is adhered to a side surface 148 of one of the links 146. More or fewer sensors may be used (e.g., 1 sensor total, two sensors per link, etc.) without departing from the scope of the present disclosure. The sensors 150 are bonded to the links 146 via an electronic-safe adhesive or other suitable attachment method to prevent them from dislodging during use. The sensors 150 generate torque data by measuring the strain or flexing of the links 146. In particular, the links 146 are configured to bend about respective bending axes parallel to but spaced from the axis of rotation of the motor output shaft. The bending of the links is detected by the sensors 150 and communicated as torque data. Other configurations can be used without departing from the scope of the present disclosure.

In the illustrated embodiment, each sensor 150 comprises a strain gauge. Each strain gauge directly senses bending of the link 146 the strain gauge is mounted to (not torque on the link) to indirectly sense torque on the motor 114.

During operation (e.g., when the motor 114 generates torque), the twisting action between the motor connector 140 and the housing connector 138 causes the links 146 to deform (e.g., bend). This deformation is detected by the sensors 150, which respond by producing torque data in the form of electrical signals proportional to the applied strain. The sensors 150 are connected to (in communication with) the controller 152 through electrical wires (not shown) that transmit the torque data to the controller. The use of multiple sensors 150 across the links 146 provides redundant measurements to enhance accuracy and reliability of torque sensing. For example, in one embodiment the controller 152 determines a measured torque value (the applied torque) based on the torque data from multiple (e.g., all of the sensors), such as by averaging torque data from the sensors 150 to determine the torque measurement.

The torque sensor assembly 120 (specifically, the motor connector 140) defines a centrally positioned shaft opening 154 for accommodating the output shaft 116, allowing the shaft to pass through the sensor while maintaining the sensor's ability to measure torque directly at its source (i.e., the motor 114).

The driver 100 can incorporate a visual feedback system for indicating torque. For example, the driver 100 can include one or more torque indicators 156 for visually indicating to the user or operator when the threshold torque has been reached. In the illustrated embodiment, the torque indicators 156 are located in the head 104. The head 104 includes the cap 124 of the output shaft assembly 122 at the distal end thereof for bracing the output shaft 116. In the illustrated embodiment, the cap 124 is formed separately from the rest of the head 104 and fastened thereto during manufacture. In other embodiments, the cap 124 may be formed as an integral part of the rest of the head 104. The cap 124 includes the torque indicators 156 spaced apart radially about the output shaft 116 and component receiver 118. The torque indicators 156 comprise a light source (e.g., a plurality of LEDs). The torque indicators 156 are arranged to illuminate the component receiver 118 and component workspace (e.g., a surface of the workpiece). When the desired torque is achieved (e.g., when the applied torque measurement equals the torque threshold), the controller 152 is configured to change a state of the torque indicators 156 to visually indicate that the desired torque has been reached. For example, the torque indicators 156 may transition from a constant “on” state to a blinking or flashing state to provide visual feedback to the user. They may also be turned off completely or their colors changed. In this way, the torque indicators 156 provide input to the user regarding the applied torque without requiring the user to divert their attention from the component/workpiece. Other torque indicators (e.g., nonvisual torque indicators) such as audible alarms or vibrations may be employed used in place of or in addition to the illustrated torque indicators 156.

The handle 106 extends downward from the head 104 to provide a holding surface for single-handed operation of the torque driver. The handle 106 defines an interior handle space 158 that holds the controller 152. The handle 106 is contoured and textured to enhance grip. The variable-position trigger 108 extends outwardly from an upper end of the handle 106 to enable user control of the driver's 100 operation. The trigger 108 provides proportional control over motor 114 speed and operation, enabling users to modulate the rate of component engagement through trigger depression. For example, the trigger 108 may be depressed a first distance to operate the motor 114 at a first rotational speed and depressed a second distance greater than the first distance to operate the motor at a second rotational speed which is greater than the first rotational speed. The trigger 108 is operably connected to the controller 152 to provide input signals corresponding to user commands for starting, stopping, and controlling the intensity of motor 114 operation.

The controller 152 is housed within the handle 106 and is the processor for the driver's operation. The controller 152 receives input signals from various sources including the variable-position trigger 108, torque sensor assembly 120, user interface 126 (e.g., torque setting actuators 132, torque control actuator(s) 130), and/or other system sensors (e.g., a temperature sensor), and processes these inputs to generate appropriate control signals for motor 114 operation and display 128 operation; the controller 152 includes or is coupled to memory storing instructions (e.g., software) for implementing these functions. For example, a torque control algorithm may be implemented via the controller 152 for comparing applied torque measurements received from the torque sensor assembly 120 against the user-selected torque threshold. The controller 152 automatically adjusts motor 114 power delivery to achieve and maintain the specified torque output. The controller 152 is configured to control the display 128 to show applied torque measurements regardless of the driver's 100 operational state (e.g., torque-limited, non-torque-limited). For example, the controller 152 stops the motor 114 (e.g., stops supplying power to the motor) when the applied torque detected by the torque sensor assembly 120 meets or exceeds the threshold torque set by the user.

The control system of the driver 100 includes the controller 152 and RAM or memory 153. The controller 152 includes control circuity which includes as CPU or processor. Broadly, the memory 153 includes (e.g., stores) processor-executable instructions for controlling the operation of the driver 100 and the components thereof. The instructions embody one or more of the functional aspects of the driver 100 and the components thereof (as described herein), with the controller 152 executing the instructions to perform said one or more functional aspects. For example, the memory 153 can store settings (e.g., user entered torque threshold) and other instructions for operating the driver 100.

The driver 100 includes a removable power supply (e.g., rechargeable battery 160) for portable operation. The base 110 of the driver 100 is configured to releasably interface with a battery 160. The battery 160 is attached to the base 110 to provide electrical power to the driver 100. The illustrated battery 160 has a compact rectangular form and includes electrical connection points to interface with corresponding contacts in the base 110, and incorporates charging and status monitoring for user convenience. The battery 160 includes a charge port 162, such as a USB-C or similar interface, that allows for onboard charging (that is, while attached to the base 110). The battery 160 further includes a charge level indicator 164 that provides visual feedback regarding the battery's state of charge. The charge level indicator 164 generally comprises four LEDs corresponding to four states of charge (25%, 50%, 75%, and 100%). When the user presses a charge indication button 166 on the battery 160, the LEDs illuminate to visually indicate a current charge level. For example, when the battery 160 is at or around 25% charge, only one LED illuminates. At or around 50% charge, two LEDs illuminate. At or around 75% charge, three LEDs illuminate. When the battery 160 is fully charged at or around 100%, all four LEDs illuminate.

The battery 160 includes secure attachment mechanisms for connection to the driver 100. Specifically, the battery includes a locking assembly to provide secure mechanical attachment to the base 110. The locking assembly comprises a lock, a lock release 170, and elevated rails 172. The elevated rails 172 interface with corresponding guides 174 at the base 110 to maintain the battery 160 at proper alignment with the base, while the lock engages to secure the battery in position. When depressed, the lock release 170 disengages the lock to permit the user to remove the battery 160 from the base 110.

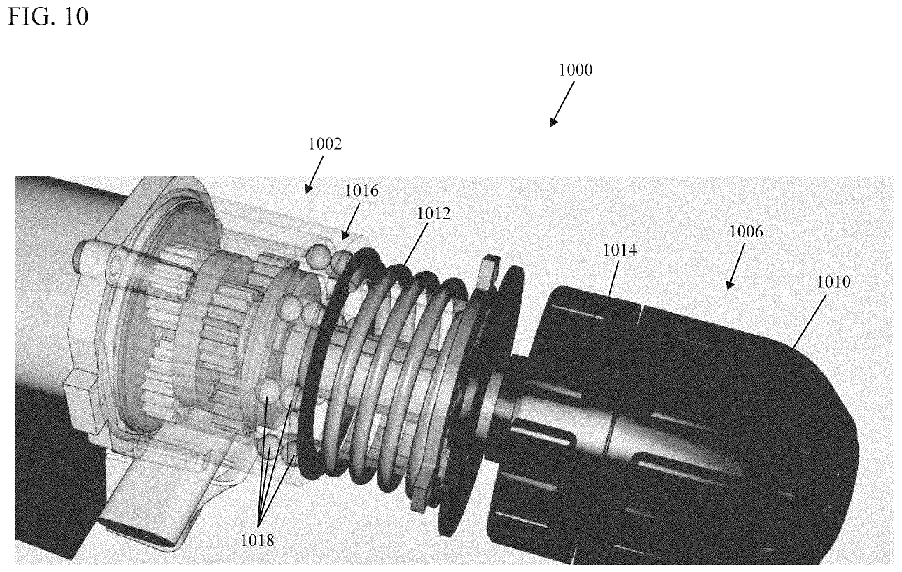

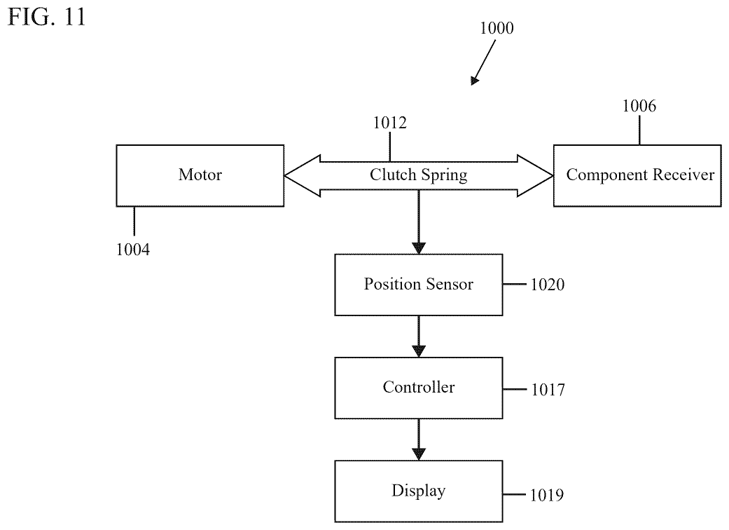

Referring to FIGS. 10 and 11, another embodiment of the torque driver according to the present disclosure is shown, and is generally indicated at reference number 1000. Unless clearly indicated or stated otherwise, the above descriptions regarding the torque driver 100 of FIGS. 1-9 also applies to the torque driver 1000 of FIGS. 10 and 11. In this embodiment, the torque driver 1000 includes a mechanical clutch 1002. The clutch 1002 is positioned between the motor 1004 and the component receiver 1006 and is configured to selectively limit the maximum torque delivered to the component receiver, and by extension the component being driven, via the output shaft 1008. The clutch 1002 slips or allows the output shaft of the motor 1004 to rotate relative to the component receiver 1006 when the applied torque meets or exceeds a threshold torque. In the illustrated embodiment, the component receiver 1006 comprises a chuck 1010 configured to receive components (e.g., bits) of varying sizes. The chuck 1010 can be opened and closed to accommodate different bit sizes and securely retain the components during operation.

The clutch 1002 includes a clutch spring 1012 whose compression determines the torque threshold. The torque threshold is thus adjusted by modifying the force applied by the clutch spring 1012, with increased spring force corresponding to higher torque thresholds and decreased spring force resulting in lower torque thresholds. The clutch spring 1012 is tightened (e.g., compressed) or loosened through rotation of the clutch actuator 1014 (e.g., a dial), which mechanically adjusts the compression applied to the clutch spring. In some aspects, the clutch actuator 1014 comprises a threaded adjuster that increases clutch spring 1012 compression when rotated in one direction and decreases spring compression when rotated in the opposite direction.

The clutch 1002 includes a clutch plate 1016 with a plurality of recesses defined at a surface thereof, as well as balls 1018 (e.g., metal balls) configured to interface with said recesses in the clutch plate. As the clutch spring 1012 tension varies (e.g., as the clutch actuator 1014 is rotated), the force required to maintain engagement between the balls 1018 and the clutch plate recesses changes proportionally. When the applied torque exceeds the threshold torque established by the clutch spring 1012, the balls 1018 disengage from (e.g., move out of) the clutch plate recesses by moving the clutch plate 1016 against the force of the spring 1012. This creates the necessary space to allow the balls 1018 to move relative to the clutch plate 1016, allowing the clutch 1002 to slip, thus preventing further torque transmission to the component receiver 1006 (broadly, allowing the output shaft of the motor to rotate relative to the component receiver).

Like the driver 100, the driver 1000 incorporates a display 119 for indicating mechanical torque settings. That is, the display 119 provides visual indication of the torque threshold established by the mechanical clutch 1002. A clutch sensor 1020 monitors a mechanical state of the clutch 1002 to determine the torque threshold. The clutch sensor 1020 comprises a position sensor that monitors the position of the clutch spring 1012. The clutch spring 1012 position directly correlates to the compression force applied by the spring, which in turn directly correlates to the torque threshold. The controller 1017 receives position data from the position sensor 1020 and converts the position information into a torque threshold through processing. In one embodiment, the memory stores data to correlate specific clutch spring 1012 positions to corresponding torque thresholds or stores an algorithm for determining the torque threshold. For example, the controller 1017 may determine the torque threshold based on a spring constant of the of the spring 1012 and a measured displacement of the clutch spring relative to its neutral position.

The clutch sensor 1020 and controller 1017 enable real-time feedback regarding mechanical torque settings. The clutch actuator 1014 can be operated to modify the clutch spring 1012 position, with the resulting torque setting change being reflected on the display 1019 through the controller's 1017 analysis of clutch spring position via the clutch sensor 1020. Alternative sensing approaches may be implemented, such as monitoring the position of the clutch actuator 1014 itself rather than the clutch spring 1012 position, or detecting other mechanical parameters that correlate to the clutch 1002 torque setting.

While the systems and methods above have been described and disclosed in certain terms and have disclosed certain embodiments or modifications, persons skilled in the art who have acquainted themselves with the disclosure, will appreciate that it is not necessarily limited by such terms, nor to the specific embodiments and modification disclosed herein. Thus, a wide variety of alternatives, suggested by the teachings herein, can be practiced without departing from the spirit of the disclosure, and rights to such alternatives are particularly reserved and considered within the scope of the disclosure.

When introducing elements of the disclosure or embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

Not all of the depicted components illustrated or described may be required. In addition, some implementations and embodiments may include additional components. Variations in the arrangement and type of the components may be made without departing from the spirit or scope of the claims as set forth herein. Additional, different or fewer components may be provided and components may be combined. Alternatively, or in addition, a component may be implemented by several components.

The above description illustrates embodiments by way of example and not by way of limitation. This description enables one skilled in the art to make and use aspects of the disclosure, and describes several embodiments, adaptations, variations, alternatives and uses of the aspects of the disclosure, including what is presently believed to be the best mode of carrying out the aspects of the disclosure. Additionally, it is to be understood that the aspects of the disclosure are not limited in its application to the details of construction and the arrangement of components set forth in the following description or illustrated in the drawings. The aspects of the disclosure are capable of other embodiments and of being practiced or carried out in various ways. Also, it will be understood that the phraseology and terminology used herein is for the purpose of description and should not be regarded as limiting.

It will be apparent that modifications and variations are possible without departing from the scope of the disclosure defined in the appended claims. As various changes could be made in the above constructions and methods without departing from the scope of the disclosure, it is intended that all matter contained in the above description and shown in the accompanying drawings shall be interpreted as illustrative and not in a limiting sense.

In view of the above, it will be seen that several advantages of the aspects of the disclosure are achieved and other advantageous results attained.

The Abstract and Summary are provided to help the reader quickly ascertain the nature of the technical disclosure. They are submitted with the understanding that they will not be used to interpret or limit the scope or meaning of the claims. The Summary is provided to introduce a selection of concepts in simplified form that are further described in the Detailed Description. The Summary is not intended to identify key features or essential features of the claimed subject matter, nor is it intended to be used as an aid in determining the claimed subject matter.

What is claimed is:

1. A torque driver for rotating a component, the torque driver comprising:
a housing;
a component receiver configured to receive the component;
a torque sensor assembly connected to the housing;
a motor connected to the torque sensor assembly, the motor having an output shaft operably connected to the component receiver to rotate the component receiver;
a controller configured to operate the motor based on a torque measurement from the torque sensor assembly.

2. The torque driver of claim 1, wherein the torque sensor assembly includes:
a housing connector for fixedly connecting the torque sensor assembly to the housing;
a motor connector for fixedly connecting the torque sensor assembly to the motor, the motor connector configured to move relative to the housing connector due to a torque being applied to the component by the torque driver.

3. The torque driver of claim 2, wherein the torque sensor assembly includes a link interconnecting the housing and motor connectors to one another, the link configured to deform due to the applied torque.

4. The torque driver of claim 3, wherein the motor connector is configured to connect to the motor radially inward with respect to the connection of the housing connector to the housing.

5. The torque driver of claim 3, wherein the link is a first link, wherein the torque sensor assembly includes a second link interconnecting the housing and motor connectors to one another, the second link configured to deform due to the applied torque.

6. The torque driver of claim 3, wherein the first and second links are configured to bend in response to the applied torque.

7. The torque driver of claim 3, wherein the torque sensor assembly includes a sensor configured to detect deformation of the link about an axis different from an axis of rotation of the output shaft.

8. The torque driver of claim 3, wherein the link is configured to bend responsive to the applied torque to deform the link.

9. The torque driver of claim 3, wherein the torque sensor assembly includes a sensor mounted on the link, the sensor being configured to measure torque data based on the deformation of the link.

10. The torque driver of claim 9, wherein the link extends radially outward away from an axis of rotation of the output shaft, the sensor being disposed on a side surface of the link extending outward away from the axis of rotation of the output shaft.

11. The torque driver of claim 2, wherein the torque sensor assembly includes a first sensor configured to measure a first torque data representative of torque applied by the motor, wherein the torque sensor assembly includes a second sensor configured to measure a second torque data representative of torque applied by the motor, wherein the controller is configured to determine a measured torque value by based on the first and second torque data.

12. The torque driver of claim 2, wherein the motor connector is at least partially nested in the housing connector.

13. The torque driver of claim 1, further comprising a user interface operably connected to the controller, the user interface configured to permit a user to input a torque threshold, wherein the controller is configured to stop the motor when the torque measurement from the torque sensor assembly equals or exceeds the torque threshold.

14. The torque driver of claim 13, further comprising a light source, the controller configured to change a state of the light source when the torque measurement from the torque sensor assembly meets or exceeds the torque threshold.

15. A torque driver for rotating a component, the torque driver comprising:
a housing;
a component receiver configured to receive the component;
a motor having an output shaft operably connected to the component receiver to rotate the component receiver;
a torque sensor assembly configured to measure a torque being applied to the component by the torque driver;
a user interface the user interface configured to permit a user to input a torque threshold, the user interface including a torque control actuator; and
a controller configured to operate in a first mode in which the controller operates the motor based on the torque threshold and a second mode in which the controller operates the motor independent of the torque threshold, the controller configured to switch between the first and second modes in response to actuation of the torque control actuator.

16. The torque driver of claim 15, wherein the user interface includes at least one torque setting actuator for changing the torque threshold.

17. The torque driver of claim 15, wherein the user interface includes a display configured to show the torque threshold.

18. The torque driver of claim 15, wherein in the first mode the controller is configured to stop the motor when a torque measurement from the torque sensor assembly equals or exceeds the torque threshold.

19. The torque driver of claim 15, wherein the user interface includes a display configured to show a value of the applied torque.

20. The torque driver of claim 15, further comprising a torque indicator configured to indicate when a torque measurement from the torque sensor assembly equals or exceeds the torque threshold.
